(19) United States
(12) Patent Application Publication
(10) Pub. No.: US 2026/0204059 A1
(43) Pub. Date: Jul. 16, 2026

(54) STRATEGY ARRANGING METHOD, APPARATUS AND DEVICE, AND MESSAGE PROCESSING METHOD, APPARATUS, DEVICE AND SYSTEM

(71) Applicant: Hangzhou Hikvision System Technology Co., Ltd., Hangzhou (CN)

(72) Inventors: Yilan SHAO, Hangzhou (CN); Yihao FENG, Hangzhou (CN); Shuai LI, Hangzhou (CN); Qiudan CAO, Hangzhou (CN); Yunfei CAO, Hangzhou (CN)

(21) Appl. No.: 19/505,550

(22) PCT Filed: Jun. 30, 2023
(86) PCT No.: PCT/CN2023/105086

§ 371 Date: Jan. 26, 2026

(30) Foreign Application Priority Data
Dec. 8, 2022 (CN) 202211574967.1

(51) Int. Cl. G06V 10/94; G06F 40/205; G06V 20/40

(52) U.S. Cl. CPC G06V 10/945; G06F 40/205; G06V 20/44

(57) ABSTRACT

The present disclosure provides a strategy arranging method, apparatus and device, and a message processing method, apparatus, device and system, where the strategy arranging method includes: determining a target event that needs to be performed with strategy arrangement; adding, according to a detected element add instruction, a target element pointed by the element add instruction to a strategy visualized arranging interface; determining a connection relation between the processing elements according to a detected connection operation instruction for the processing elements in the strategy visualized arranging interface; and determining parameters of the processing elements according to a detected parameter editing instruction for the processing elements in the strategy visualized arranging interface; and when a strategy saving instruction is detected, generating and saving a strategy of the target event according to the processing elements, the connection relation between the processing elements, and the parameters of the processing elements.

### CROSS REFERENCE TO RELATED APPLICATIONS

The present disclosure claims priority to Chinese patent application No. 202211574967.1, filed on Dec. 8, 2022, which is hereby incorporated by reference in its entirety.

### TECHNICAL FIELD

The present disclosure relates to the technical field of AI intelligent algorithm, and in particular, to a strategy arranging method, device and apparatus, and a message processing method, apparatus, device and system.

### BACKGROUND

With continuous development of Artificial Intelligence (AI) technology, AI products gradually become an important component of various industry systems, and AI products intelligently analyze monitoring data of monitoring sites deployed in cities by using a deep learning algorithm, so as to discover whether an abnormal event exists in a monitoring area and automatically provide alarm data.

Due to the diversity and complexity of events, there may be false or repeated reports in messages of intelligently identified events, and filtering processing needs to be performed.

### SUMMARY

In view of this, the present disclosure provides a strategy arranging method, apparatus and device, and a message processing method, apparatus, device and system.

According to a first aspect of embodiments of the present disclosure, a strategy arranging method is provided, including:
determining a target event that needs to be performed with strategy arrangement;
adding, according to a detected element add instruction, a target element pointed by the element add instruction to a strategy visualized arranging interface, where the target element includes processing elements, and the processing elements include at least one of a function element, an algorithm element, and an execution element; where the function element is configured to perform logical operation processing on to-be-processed data, the algorithm element is configured to perform algorithm processing on the to-be-processed data by using a preset algorithm, and the execution element is configured to control a specified device to perform a corresponding action;
determining a connection relation between the processing elements according to a detected connection operation instruction for the processing elements in the strategy visualized arranging interface; and determining parameters of the processing elements according to a detected parameter editing instruction for the processing elements in the strategy visualized arranging interface; and
when a strategy saving instruction is detected, generating and saving a strategy of the target event according to the processing elements, the connection relation between the processing elements, and the parameters of the processing elements.

According to a second aspect of embodiments of the present disclosure, a message processing method is provided, including:
acquiring a target element included in a target strategy when a running instruction for the target strategy is detected, where the target strategy is generated by arranging according to the method according to the first aspect; and
determining a running sequence of the processing elements according to the connection relation between the processing elements in the target element, and running the processing elements according to the running sequence, so that the running processing elements process a to-be-processed event message by using a corresponding parameter.

According to a third aspect of embodiments of the present disclosure, a strategy arranging apparatus is provided, including:
a first determining unit, configured to determine a target event that needs to be performed with strategy arrangement;
an arranging unit, configured to: adding, according to a detected element add instruction, a target element pointed by the element add instruction to a strategy visualized arranging interface, where the target element includes processing elements, and the processing elements include at least one of a function element, an algorithm element, and an execution element; where the function element is configured to perform logical operation processing on to-be-processed data, the algorithm element is configured to perform algorithm processing on the to-be-processed data by using a preset algorithm, and the execution element is configured to control a specified device to perform a corresponding action;
a second determining unit, configured to determine a connection relation between the processing elements according to a detected connection operation instruction for the processing elements in the strategy visualized arranging interface; and determine parameters of the processing elements according to a detected parameter editing instruction for the processing elements in the strategy visualized arranging interface; and
a generating unit, configured to generate and save a strategy of the target event according to the processing elements, the connection relation between the processing elements, and the parameters of the processing elements when a strategy saving instruction is detected.

According to a fourth aspect of embodiments of the present disclosure, a strategy arranging device is provided, including a processor, a communication interface, a memory and a communication bus, where the processor, the communication interface and the memory communicate to each other through the communication bus;
the memory is configured to store a strategy visualized arranging software program; and
the processor is configured to perform the strategy visualized arranging software program stored on the memory to implement the strategy arranging method provided by the first aspect.

According to a fifth aspect of embodiments of the present disclosure, a message processing apparatus is provided, including:
an acquiring unit, configured to acquire a target element included in a target strategy when a running instruction for the target strategy is detected, where the target strategy is generated by arranging according to the method according to the first aspect; and
a processing unit, configured to determine a running sequence of the processing elements according to the connection relation between the processing elements in the target element, and run the processing elements according to the running sequence, so that the running processing elements process a to-be-processed event message by using a corresponding parameter.

According to a sixth aspect of embodiments of the present disclosure, a message processing device is provided, including a processor, a communication interface, a memory and a communication bus, where the processor, the communication interface and the memory communicate to each other through the communication bus;
the memory is configured to store a software program for running an arranged strategy; and
the processor is configured to perform the software program for running the arranged strategy stored on the memory to implement the message processing method provided by the second aspect.

According to a seventh aspect of embodiments of the present disclosure, a message processing system is provided, including the strategy arranging device provided by the fourth aspect and the message processing device provided by the sixth aspect.

According to the strategy arranging method of the embodiments of the present disclosure, a target event that needs to be performed with strategy arrangement is determined, a target element pointed by the element add instruction is added to a strategy visualized arranging interface according to a detected element add instruction, a connection relation between the processing elements is determined according to a detected connection operation instruction for the processing elements in the strategy visualized arranging interface; and parameters of the processing elements are determined according to a detected parameter editing instruction for the processing elements in the strategy visualized arranging interface, and further, when a strategy saving instruction is detected, a strategy of the target event is generated and saved according to the processing elements, the connection relation between the processing elements, and the parameters of the processing elements, by which strategy visualized arrangement for a specific event is implemented, pertinence of strategy arrangement is improved, and intuitiveness of a strategy arranging process through a visualized strategy arranging manner.

### BRIEF DESCRIPTION OF DRAWINGS

FIG. 1 is a schematic flowchart of a strategy arranging method according to an embodiment of the present disclosure.

FIG. 2 is a schematic flowchart of a message processing method according to an embodiment of the present disclosure.

FIG. 3A is a schematic diagram of strategy effect statistics according to an embodiment of the present disclosure.

FIG. 3B is a schematic diagram of a strategy output event ratio according to an embodiment of the present disclosure.

FIG. 4 is a schematic flowchart of strategy arranging and executing according to an embodiment of the present disclosure.

FIG. 5 is a schematic diagram of visualized strategy arrangement according to an embodiment of the present disclosure.

FIG. 6 is a schematic structural diagram of a strategy arranging apparatus according to an embodiment of the present disclosure.

FIG. 7 is a schematic diagram of a hardware structure of a strategy arranging device according to an embodiment of the present disclosure.

FIG. 8 is a schematic structural diagram of a message processing apparatus according to an embodiment of the present disclosure.

FIG. 9 is a schematic diagram of a hardware structure of a message processing device according to an embodiment of the present disclosure.

FIG. 10 is a schematic structural diagram of a message processing system according to an embodiment of the present disclosure.

### DETAILED DESCRIPTION

Exemplary embodiments will be described in detail herein, examples of which are illustrated in the accompanying drawings. When the following description refers to the drawings, unless otherwise indicated, same numerals in different drawings indicate same or similar elements. The implementations described in the following exemplary embodiments do not represent all implementations consistent with the present disclosure. Rather, they are merely examples of apparatuses and methods consistent with some aspects of the present disclosure as specifically defined in the appended claims.

The terminology used in the present disclosure is for the purpose of describing particular embodiments only and is not intended to limit the present disclosure. As used in the present disclosure and the appended claims, singular forms “a”, “the”, and “said” are also intended to include plural forms unless the context clearly indicates other meanings.

To enable those skilled in the art to better understand the technical solutions provided in the embodiments of the present disclosure, and enable the foregoing purposes, features, and advantages of the embodiments of the present disclosure to be more apparent and easier to understand, the technical solutions in the embodiments of the present disclosure are further described in detail below with reference to the accompanying drawings.

It should be noted that a sequence number of each step in the embodiments of the present disclosure does not mean an execution sequence, and the execution sequence of each process should be determined based on a function and internal logic of the process, and should not constitute any limitation on an implementation process of the embodiments of the present disclosure.

AI products may intelligently analyze monitoring data of monitoring sites deployed in cities by using a deep learning algorithm, and may discover whether an abnormal event exists in a monitoring area, and report alarm data to a background system when the abnormal event exists, where the alarm data may be sent in a form of a message. Due to diversity and complexity of an alarm event (i.e., the abnormal event), there may be a case of false or repeated reports, the alarm event needs to be filtered according to a certain strategy. Based on this, embodiments of the present disclosure provide a strategy arranging method.

The strategy arranging method shown in the embodiment may be performed by an electronic device such as a terminal device or a server, and the terminal device may be a fixed terminal or a mobile terminal, for example, a mobile phone, a tablet computer, a desktop computer, or an all-in-one machine, and the server includes a local server or a cloud server, which is not limited in the present embodiment.

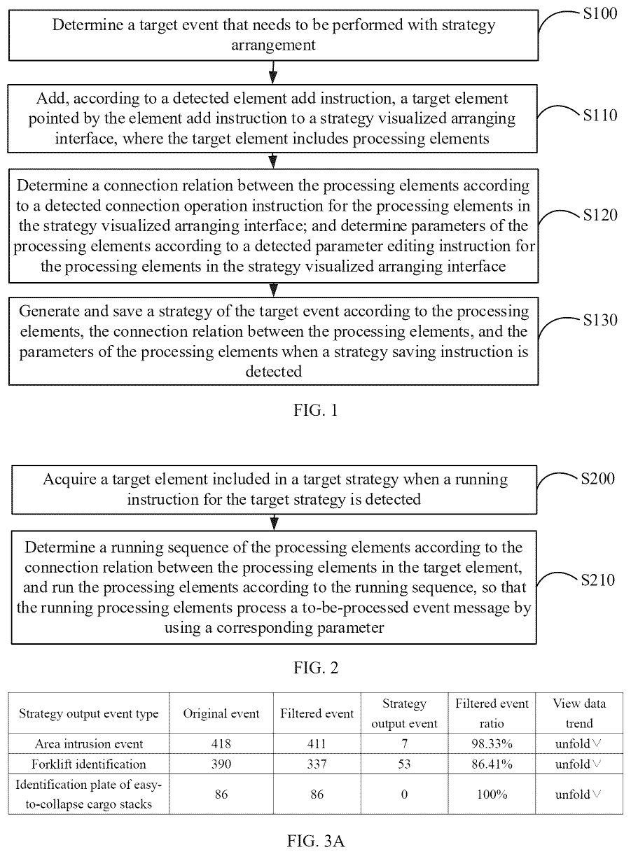

FIG. 1 is a schematic flowchart of a strategy arranging method according to an embodiment of the present disclosure. As shown in FIG. 1, the strategy arranging method may include following steps:

Step S100, determining a target event that needs to be performed with strategy arrangement.

In the embodiments of the present disclosure, considering that filtering conditions applicable to filtering different types of alarm events are different, if unified filtering setting is directly carried out on all alarm events, filtering effect is poor, different types of accurate alarm events cannot be accurately filtered out, and a noise of alarm data is still large.

Based on this, in the embodiments of the present disclosure, to optimize an alarm event filtering effect, a strategy arranging method for a specific event may be provided, to obtain a strategy used to filter the specific event.

For example, a user may determine, according to an actual requirement, an event (referred to herein as a target event) that needs to be performed with strategy arrangement, and trigger strategy arrangement for the target event by inputting a strategy arranging instruction for the target event.

For example, the target event may include one type of event or multiple types of events.

For the strategy arranging instruction for the target event, for example, an event selection interface may be provided in a strategy visualized arranging interface, for example, an event list may be displayed in a specified area in the strategy visualized arranging interface, and a user may select the target event from the event list according to a requirement and input the strategy arranging instruction (for example, click the target event, and select the strategy arranging in a pop-up function menu) to trigger strategy arrangement for the target event.

For the strategy arranging instruction for the target event, for another example, a strategy arranging function button may be provided in the strategy visualized arranging interface, and the user may trigger display of a strategy arranging window by clicking the function button, and input identifier information of the target event (e.g., an event code of the target event) into the window, and trigger strategy arrangement for the target event by clicking a determining function button in the strategy arranging window.

Illustratively, a strategy arranging step description may be displayed in the strategy visualized arranging interface in response to a detected prompt description instruction, so that the user can understand steps for the strategy arrangement.

Step S110, adding, according to a detected element add instruction, a target element pointed by the element add instruction to a strategy visualized arranging interface, where the target element includes processing elements, and the processing elements include at least one of a function element, an algorithm element, and an execution element; where the function element is configured to perform logical operation processing on to-be-processed data, the algorithm element is configured to perform algorithm processing on the to-be-processed data by using a preset algorithm, and the execution element is configured to control a specified device to perform a corresponding action.

In the embodiments of the present disclosure, when the target event that needs to be performed with strategy arrangement is determined in the above manner, a target element required for filtering the target event may be added to the strategy visualized arranging interface.

For example, the user may select one or more target elements in a display page, and add the selected target elements to the strategy visualized arranging interface by dragging.

Correspondingly, according to a detected element add instruction (such as the above instruction triggered by the drag operation), the target element (such as the selected target element) pointed by the element add instruction is added to the strategy visualized arranging interface.

Illustratively, the strategy visualized arranging interface supports a centering operation (i.e., display a target element added to the strategy visualized arranging interface in a middle area of the interface), a zoom operation (scaling up or down the interface and the target element displayed in the interface according to a proportion), an undo operation (e.g., cancel an operation for the target element last time, such as an add operation), and a clear operation (deleting all added target elements), etc.

For example, the target element may include but is not limited to a processing element. For example, the processing element may include at least one of a function element, an algorithm element, and an execution element.

The function element may be configured to perform logical operation processing on to-be-processed data, that is, logical operation processing may be performed on the to-be-processed data by running the function element, for example, logical decision processing and function operation processing may be performed; where the to-be-processed data may be a message reported by a monitoring site after identifying an abnormal event, which may also be referred to as a to-be-processed event message. For example, the function element may include, but is not limited to, a filter element, a shunt element, a single-point deduplication element (for example, deduplicate messages reported by a same monitoring site at an interval less than a preset time threshold), or the like.

For example, when the shunt element is running, the to-be-processed event message may be output to different elements based on input data and a determining rule of the shunt element.

For example, taking a forklift recognition scenario as an example, in a safe production environment, during a working process of the forklift, no person is allowed to be around the forklift. For image data collected by a monitoring front end of the forklift working scenario, forklift identification can be carried out, and under a condition that the forklift is identified, a forklift identification event can be triggered (the event can carry address information of a captured image including the forklift identification event); input data of the shunt element may include the address information of the captured image of the forklift identification event, and a position and size of a forklift detection block in the image; during operation of the shunt element, whether the size is greater than a preset size threshold value or not can be determined according to the size of the forklift detection block; if the size is greater than the preset size threshold, the captured image can be output to a human body detection element, so that human body detection is carried out according to the original captured image by running the human body detection element, so as to determine whether there are people around the forklift or not; otherwise, the captured image is output to an image magnifying and capturing element, and the captured image of the forklift identification event is magnified by running the image magnifying and capturing element, so that subsequently whether there are people around the forklift or not is detected more accurately.

The algorithm element may be configured to perform algorithm processing on the to-be-processed data by using a preset algorithm, that is, algorithm processing may be performed on the to-be-processed data by running the algorithm element and using the preset algorithm. For example, the algorithm element may include, but is not limited to, a similarity comparison element or an image secondary analysis element, for example, an image quality scoring element (configured to perform quality scoring on an obtained image by using a preset image quality scoring algorithm).

The execution element is configured to control a specified device to perform a corresponding action, that is, the specified device is controlled to perform a corresponding action by running the execution element. For example, the execution element may include, but is not limited to, a preset point rotation control element (configured to control a specified monitoring front end to rotate to a specified preset point), an image capturing element, or an image magnifying and capturing element, or the like.

Step S120, determining a connection relation between the processing elements according to a detected connection operation instruction for the processing elements in the strategy visualized arranging interface; and determining parameters of the processing elements according to a detected parameter editing instruction for the processing elements in the strategy visualized arranging interface.

In the embodiments of the present disclosure, after the required target element is added to the strategy visualized arranging interface, the user may arrange the target element in the strategy visualized arranging interface, which may include but is not limited to associating processing elements, editing parameters of the processing elements, and the like.

Correspondingly, after the target element pointed by the element add instruction is added to the strategy visualized arranging interface, on one hand, the connection relation between the processing elements may be determined according to a detected connection operation instruction for the processing elements in the strategy visualized arranging interface.

On the other hand, the parameters of the processing elements may be determined according to a detected parameter editing instruction for the processing elements in the strategy visualized arranging interface.

For example, for a processing element, a parameter of the processing element may include a parameter used to process input data. For example, for a filter element for filtering data generated in a specific time or space, a parameter of the filter element may include a filtering time period or a spatial range; for an algorithm element for performing human body detection on an obtained image, a parameter of the algorithm element may include a confidence threshold, and the like.

Illustratively, the processing element may be obtained by importing a package, packaging the processing element, defining parameters such as input and output of the processing element, or the processing element may be obtained by importing an element package.

Step S130, when a strategy saving instruction is detected, generating and saving a strategy of the target event according to the processing elements, the connection relation between the processing elements, and the parameters of the processing elements.

In the embodiments of the present disclosure, when the required processing element is added in the foregoing manner, and the connection relation between the processing elements and the parameters of the processing elements are arranged, the user may store the arranged strategy.

For example, the user may trigger the strategy saving instruction by clicking a saving function button in the strategy visualized arrangement interface.

Correspondingly, when the strategy saving instruction is detected, the strategy of the target event may be generated and saved according to the processing elements added to the strategy visualized arranging interface, the connection relation between the processing elements, and the parameters of the processing elements.

In can be learned that, in the method flow shown in FIG. 1, a target event that needs to be performed with strategy arrangement is determined, a target element pointed by the element add instruction is added to a strategy visualized arranging interface according to a detected element add instruction, a connection relation between the processing elements is determined according to a detected connection operation instruction for the processing elements in the strategy visualized arranging interface; and parameters of the processing elements are determined according to a detected parameter editing instruction for the processing elements in the strategy visualized arranging interface, and further, when a strategy saving instruction is detected, a strategy of the target event is generated and saved according to the processing elements, the connection relation between the processing elements, and the parameters of the processing elements, by which strategy visualized arrangement for a specific event is implemented, pertinence of strategy arrangement is improved, and intuitiveness of a strategy arranging process through a visualized strategy arranging manner.

In some embodiments, the target element may further include an event input element. The strategy arranging method may further include: creating the event input element for the target event when a strategy arranging instruction for the target event is detected; or creating an initial event input element when an event input element creation instruction is detected; and determining the event input element of the target event according to a detected event identifier configuration instruction for the initial event input element.

For example, strategy arrangement for the target event may be triggered by creating the event input element for the target event.

In an example, the target event may be first determined, for example, the target event is selected from an event list, or an event identifier of the target event is input into a specified input area, and then an event input element of the target event is created in response to detecting a strategy arranging instruction for the target event, thereby triggering strategy arrangement for the target event.

For example, it is taken as an example that the event identifier is an event code, and the event code may be a character string used to uniquely identify one type of event.

In another example, the event input element may be first created, and then the event identifier of the target event is configured in the event input element, so as to create the event input element of the target event.

Illustratively, the initial event input element may be created when the event input element creation instruction is detected, and the event identifier of the target event may be obtained according to the event identifier configuration instruction when the event identifier configuration instruction for the initial event input element is detected. The event identifier of the target event is configured in the initial event input element to obtain the event input element of the target event.

In the embodiments of the present disclosure, a manner of detecting an instruction may be various, and in a possible implementation, a virtual button corresponding to each instruction may be preset in the strategy visualized arranging interface, and a click detection instruction for the virtual button may be detected; in another possible implementation, the instruction may be detected by analyzing a command line input by the user.

For example, event source information is set in the event input element, and the event source information is used to obtain a to-be-processed event message based on the event source information when the event input element is running. Based on this, creating the event input element of the target event may further include obtaining the event source information of the target event.

For example, event source type information may further be set in the event input element, and the event source type information is used to indicate a source type of the to-be-processed event message obtained by the event input element, for example, a central end analysis (an event triggered by a central end device such as a central platform) or an edge end analysis (an event triggered by an edge end device such as a capturing machine).

For example, considering that in the central end analysis, data of a plurality of monitoring sites are usually analyzed to determine whether a specified event exists; and in the edge end analysis, a single monitoring site usually analyzes data of the current monitoring site to determine whether a specified event exists, and therefore, when a same algorithm is used for analysis, accuracy of the central end analysis is generally lower than accuracy of the edge end analysis, so that when event reporting accuracy statistics is performed, the event source type information in the event input element may be distinguished, and statistics is performed on the central end analysis and the edge end analysis respectively.

For example, the event source information may include an event input address, and the to-be-processed event message may be obtained based on the event input address.

Correspondingly, after the target element is added to the strategy visualized arranging interface according to the above manner, in addition to determining the connection relation between the processing elements in the foregoing manner, the connection relation between the event input element and the processing elements may also be determined based on a detected connection operation instruction for the event input element.

In some embodiments, the target element may further include an event output element, and the event output element is provided with an output address for outputting data according to the output address when the event output element is running. After adding the target element pointed by the element add instruction to the strategy visualized arranging interface according to the detected element add instruction, the method may further include: determining a connection relation between the event output element and the processing elements according to the detected connection operation instruction for the event output element.

For example, when strategy arrangement is performed on the target event, in addition to arranging the processing elements in the foregoing manner, the event output element may also be set, and an output address may be set in the event output element, so that when the event output element is running, output data obtained by executing the strategy may be output to a specified address.

Correspondingly, after the target element is added to the strategy visualized arranging interface according to the above manner, in addition to determining the connection relation between the processing elements in the foregoing manner, the connection relation between the event output element and the processing elements may also be determined based on a detected connection operation instruction for the event output element.

For example, when the target element includes the event input element and the event output element, the connection relation between the target elements may be set by taking the event input element as a head and taking the event output element as a tail, and the connection sequence of the processing elements may be set as required.

For example, a strategy arranging and executing process can be referred from FIG. 4. As shown in FIG. 4, an element library stores elements (may be referred to as strategy elements) for strategy arrangement. The strategy element may include an event input element, an event output element, and a processing element; the processing element may include, but is not limited to, a function element, an algorithm element, and an execution element.

For example, the function element may include but is not limited to a single-point deduplication element, a multi-point deduplication element, a function operation element, and the like. The algorithm element may include, but is not limited to, a similarity comparison element and an error library comparison element. The execution element may include, but is not limited to, a preset point rotation control element and a capturing element.

In a strategy arranging process, a target element in the element library pointed by the element add instruction may be added to the strategy visualized arranging interface (which may be referred to as a canvas in this example) according to the detected element add instruction, and a connection relation between the target elements according to the detected connection operation instruction for each target element in the canvas; and parameters of the target elements are determined according to the detected parameter editing instruction for the target elements in the canvas.

For example, the target element may include an event input element, an event output element, and at least one processing element.

When the strategy saving instruction is detected, a corresponding strategy may be generated and saved in a strategy library according to the target elements, the connection relation between the target elements, and parameters of the target elements.

For example, the strategies stored in the strategy library may include, but are not limited to, a traffic event pedestrian intrusion application strategy, a traffic event congestion application strategy, a bank greeting detection strategy, playing with mobile phone during work detection strategy, and the like.

In a strategy execution process, for any strategy in the strategy library, when it is determined that the strategy needs to be executed, a corresponding target element may be obtained from the element library according to a target element involved in the strategy, a running sequence of each target element is determined according to a connection relation between target elements included in the strategy, each target element is executed according to the running sequence, and the running target element processes the to-be-processed event message by using a corresponding parameter.

It can be learned that the strategy arranging method provided in the embodiments of the present disclosure can perform visualized strategy arrangement for an event message, and not only general processing elements can be provided, such as a single-point periodic deduplication element, a single-point time period deduplication element, a shunt element, a condition filter element, a condition deletion element, a single-point aggregation element, a target block filter element, a similarity comparison element, an image secondary analysis element, and a time sequence calculation element; but also a processing element used for a specific scenario can be provided, such as an indoor human body detection element, and usage requirements of various different scenarios can be satisfied, thereby improving applicability of the strategy arranging solution.

In the strategy arranging process, for an event that needs to be performed with the strategy arrangement, required target elements can be selected to be added into the strategy visualized arranging interface according to an actual usage scenario, and connection relation and parameters of the target elements can be set to complete strategy arrangement of the event, by which strategy visualized arrangement for the specific event is implemented, thereby improving pertinence of the strategy arrangement and improving intuitiveness of the strategy arranging process.

In some embodiments, the event input element includes an event data model conversion function, and the event data model conversion function is used to parse the obtained event message, and add description information to each specified field in the event message, where the description information is used to facilitate the processing elements to determine a meaning of a corresponding field.

For example, considering that in an actual application, formats of alarm messages of different events may be different, a processing element may be unable to identify meanings of fields in messages with different formats, and further, processing of the processing elements may be abnormal. For ease of description, an alarm message of an event is referred to as an event message or a to-be-processed event message hereinafter.

Based on this, in the embodiments of the present disclosure, the event input element may include an event data model conversion function. For an obtained event message, the event input element may parse the event message first, and add description information to each specified field (for example, a field whose field value is used in a subsequent processing procedure, or a pre-specified field) in the event message, where the description information is used to interpret a meaning of each specified field, so that the processing element may determine the meaning of the specified field based on the description information of the specified field.

For example, for any to-be-processed event message, when an event input element is running, the to-be-processed event message may be parsed, to determine a meaning of each specified field in the to-be-processed event message, and generate corresponding description information. For each specified field in the to-be-processed event message, a correspondence between a field path (used to identify a location of the field in the to-be-processed event message) and corresponding description information may be determined, and the correspondence is transmitted to the processing element, so that the processing element may obtain, based on the correspondence, description information corresponding to the field path, and determine a meaning of the specified field in the to-be-processed event message based on the description information.

In some embodiments, determining the parameters of the processing elements according to the detected parameter editing instruction for the processing elements in the strategy visualized arranging interface may include: when an operation instruction of pasting the event message of the target event to a specified area of an event message parsing interface is detected, parsing the event message of the target event to determine field information included in the event message of the target event; and determining the parameters of the processing elements according to a parameter editing instruction of a target field in the detected event message for the target event.

For example, in addition to the strategy visualized arranging interface, an event message parsing interface may be preset. When parameter editing needs to be performed on the processing element, a related person may enter the event message parsing interface, and input a parsing instruction for the event message of the target event or perform a preset parsing operation, where the preset parsing operation is, for example, pasting the event message of the target event to a specified area of the event message parsing interface.

Correspondingly, when an operation instruction for pasting an event message of the target event to a specified area of an event message parsing interface is detected, the event message of the target event is parsed, field information included in the event message of the target event is determined.

For example, for any field, field information obtained through parsing may include, but is not limited to, a field identifier, a field type, a field name, a parsed value, and the like.

For example, field information included in the event message of the target event may be displayed, and based on the displayed field information, a related person may select a field (referred to as a target field herein) that needs to be performed with parameter editing for a processing element, and input a parameter editing instruction for the target field.

Correspondingly, for any processing element, the parameters of the processing elements may be determined according to the detected parameter editing instruction for the target field in the event message for the target event.

To enable a person skilled in the art to better understand the visualized strategy arranging solution in the embodiments of the present disclosure, the following is described with reference to an example.

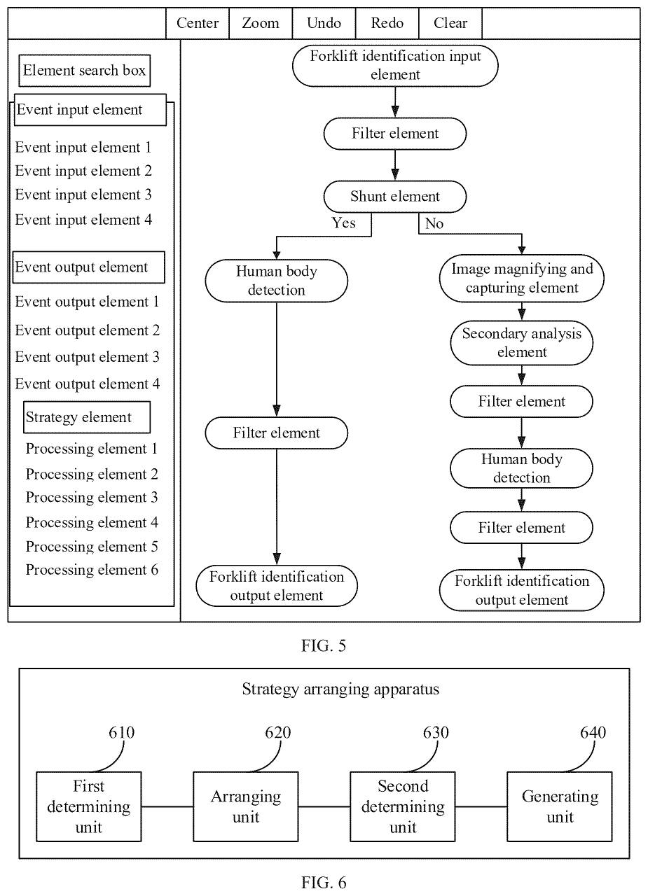

As shown in FIG. 5, the strategy visualized arranging interface includes an element list, and the element list includes various strategy elements to be selected by a user, and may include but is not limited to an event input element, an event output element, and a processing element.

In the strategy arranging process, the target element may be selected to be added to the strategy visualized arranging interface according to requirements. Taking a forklift recognition scenario as an example, the target element may include: an event input element (a forklift recognition input element shown in the figure), an event output element (a forklift recognition output element shown in the figure), and a processing element.

The processing element may include a function element (e.g., a filter element, a shunt element shown in the figure), an algorithm element (e.g., a human body detection element, a secondary analysis element shown in the figure), and an execution element (e.g., an image magnifying and capturing element shown in the figure).

The visualized arranging interface supports operation instructions such as “center”, “zoom”, “und”, “redo”, and “clear”, and may support adjusting an interface display ratio in response to detecting the operation instruction of “zoom”.

For the target elements added into the strategy visualized arranging interface, the connection relation and parameters between the target elements may be determined according to requirements, and in a strategy running process, a running sequence of the target elements may be determined according to the connection relation between the target elements.

Taking the scenario shown in FIG. 5 as an example, considering that in the reported forklift identification event, there may be a problem that the forklift target block is too small to determine whether there is a human body (excluding a person in the forklift cab) in the forklift target block, therefore, the forklift identification element may be connected to the filter element to filter the forklift identification event with too small forklift target block (for example, a target block area is less than a first area threshold), and the forklift identification event where the forklift target block is greater than or equal to the first area threshold may enter the shunt element for processing.

The shunt element may be configured to determine whether the area of the forklift target block corresponding to the forklift identification event is greater than a second area threshold (the second area threshold is greater than the first area threshold), and when the forklift target block corresponding to the forklift identification event is greater than the second area threshold, the forklift identification event is turned to the human body detection element to determine whether a human body exists in the forklift target block, the forklift identification event without any human body in the forklift target block is filtered through the filter element, and the forklift identification event with a human body in the forklift target block is output through the forklift identification output element.

When the forklift target block corresponding to the forklift identification event is smaller than or equal to the second area threshold value, an image magnifying and capturing element is turned to, a corresponding monitoring site is controlled to perform image magnifying and capturing, forklift detection is performed on an image obtained by image magnifying and capturing through a secondary analysis element to obtain a forklift target block, and the forklift identification event where no forklift target block exists or the forklift target block has a very low confidence is filtered out through the filter element.

For the forklift identification event output by the filter element to the human body detection element, human body detection can be performed to determine whether any human body exists in the forklift target block, the forklift identification event without any human body in the forklift target block is filtered, and the forklift identification event with a human body in the forklift target block is output through the forklift identification output element.

Embodiments of the present disclosure further provide a message processing method, the method can be performed by an electronic device such as a terminal device or a server, and the terminal device may be a fixed terminal or a mobile terminal, for example, a mobile phone, a tablet computer, a desktop computer, or an all-in-one machine, and the server includes a local server or a cloud server, which is not limited in the present embodiment.

Referring to FIG. 2, FIG. 2 is a schematic flowchart of a message processing method according to an embodiment of the present disclosure. As shown in FIG. 2, the message processing method may include following steps:

Step S200: acquiring a target element included in a target strategy when a running instruction for the target strategy is detected.

Illustratively, the target strategy may be generated by arranging according to the method described in the method procedure shown in FIG. 1.

In the embodiments of the present disclosure, the user may execute the strategy generated by arranging according to the method described in the method procedure shown in FIG. 1 based on an actual requirement.

For any strategy (referred to herein as a target strategy) generated by arranging according to the method described in the method procedure shown in FIG. 1, when a running instruction for the target strategy is detected, a target element included in the target strategy may be acquired.

Illustratively, for components other than the event input component, the component may be generated by importing a package and performing component packaging, and input and output of a computing component are defined, so as to obtain the target component included in the target strategy, or the corresponding component may be obtained by importing a component package.

It should be noted that, for any strategy, a running range of the strategy may be further configured, for example, a running time range and/or a running space range, that is, it is configured in which time periods and/or in which event occuring sites the strategy needs to be executed.

Correspondingly, when there is a configuration of a running time range, the strategy may be automatically executed within the configured running time range; and when there is a running space range, related events within the running space range may be processed by using the strategy

Step S210: determining a running sequence of the processing elements according to the connection relation between the processing elements in the target element, and running the processing elements according to the running sequence, so that the running processing elements process a to-be-processed event message by using a corresponding parameter.

In the embodiments of the present disclosure, when any to-be-processed event message is processed by using a strategy, a running sequence of each processing element may be determined based on a connection relation between processing elements in the target element, and the processing elements are executed based on the running sequence.

For any processing element, when running the processing element, the processing element may process the to-be-processed event message by using a corresponding parameter, where the message includes time, a location (or a monitoring front end site), an image (or an image address), and an image detection result (for example, a license plate recognition result).

For example, for the filter element, whether the to-be-processed event message needs to be filtered may be determined based on values of fields such as a time and a site in the to-be-processed event message.

For another example, for the image quality scoring element, a corresponding image may be obtained according to the image address carried in the to-be-processed event message, and quality scoring is performed on the obtained image by using a preset image quality scoring algorithm, to obtain a quality score of the image.

In some embodiments, the target element further includes an event input element; and before running the processing element according to the running sequence, and before the running processing element processes the to-be-processed event message by using the corresponding parameter, the method may further include: running the event input element in the target element, and acquiring the to-be-processed event message according to event source information set in the event input element.

For example, the event source information may include an event input address. When the target element includes the event input element, during running of the strategy, the event input element may be executed first, and the to-be-processed event message is obtained according to the event input address set in the event input element.

For example, a source of the to-be-processed event message may include but is not limited to a front-end device, a central end device, a trusted third-party platform, or the like.

For example, it is taken as an example that the target strategy is a strategy corresponding to the target event, the event input address may be an address of a message queue (e.g., a Kafka queue) that stores an event message (i.e., an alarm message) of the target event, and the event messages generated by the target event may be stored in the message queue, and when running the event input element of the target strategy, the event message may be acquired from the message queue according to the event input address set in the event input element, and the acquired event message is used as the to-be-processed event message.

Illustratively, when the to-be-processed event message is obtained according to the event input address, an event code of each event message in the message queue corresponding to the event input address needs to be parsed (to facilitate distinguishing event messages of different types of events, the event message may further include an event code, and one message queue may store event messages of different event codes), an event message whose event code is consistent with the event code set in the event input element in the message queue is pulled as the to-be-processed event message.

Illustratively, when a running time range and/or a running space range are configured in the strategy, when the event input element is acquiring the to-be-processed event message, an event occurrence time (for example, a reporting time of the event message) and/or a site identifier (or referred to as a scenario identifier) of each event message in the message queue corresponding to the event input address needs to be parsed, so as to determine whether an event occurrence time corresponding to the event message is within a preset running time range, and/or whether an event occurrence location is within a preset running space range. When the event occurrence time corresponding to the event message is not within the preset running time range, or the event occurrence location is not within the preset running space range, the event message is not pulled.

Alternatively, after the event input element pulls the event message from the message queue corresponding to the event input address, an event occurrence time and/or a site identifier (or referred to as a scenario identifier) of the pulled event message is parsed, so as to determine whether the event occurrence time corresponding to the event message is within the preset running time range and/or whether the event occurrence location is within the preset running space range, and when the event occurrence time corresponding to the event message is not within the preset running time range or the event occurrence location is not within the preset running space range, the event message is filtered and no longer output to the next element.

For example, it is assumed that a preset running time range in the strategy is 9:00-17:00, and a running space range is sites ABCDEF. Then, for an event message whose event occurrence time in the message queue corresponding to the event input address is 8:00 and whose event occurrence location is site A (that is, the event occurrence time is not within the preset running time range, but the event occurrence location is within the preset running space range), the event input element may not be pulled, or the event input element may be filtered out after being pulled.

For an event message whose event occurrence time in the message queue corresponding to the event input address is 10:00 and whose event occurrence location is site T (that is, the event occurrence time is within the preset running time range, but the event occurrence location is not within the preset running space range), the event input element may not be pulled, or the event input element may be filtered out after being pulled.

In some embodiments, the target element further includes an event output element; and after the processing elements are executed according to the running sequence, and the processing elements process the to-be-processed event message by using the corresponding parameter, the method may further include: in a case of running the event output element in the target element, data is output according to an output address set in the event output element.

For example, when the target element further includes the event output element and the event output element in the target element is running, data may be output according to an output address set in the event output element.

For example, the output address may be a storage path of the output data, and when the event output element is running, the output data may be stored in a specified storage path based on the output address set in the event output element, for example, stored in a valid alarm message queue.

Illustratively, the parameter of the event output element may further include output format information, so that when the event output element is running, the output data may be saved to the specified storage path according to the set output format information.

It should be noted that, in the embodiments of the present disclosure, an event code may also be set in the event output element, and the event code set in the event output element may be different from the event code set in the event input element, that is, the event code in the event message output by the event output element may be different from the event code in the event message pulled by the event input element.

Still taking the forklift identification scenario as an example, in the monitoring front end of the forklift working scenario, it may be configured to perform image capturing when the forklift is detected, and a corresponding event message is generated (assuming that the event code is event code 1, which is used to identify an event type of identifying a forklift). However, in an actual forklift identification scenario, an alarm is given only when a person is identified around the forklift, and therefore, for a forklift identification event, an event code in the event input element of the forklift identification event may be an event code 1, and therefore, all events triggered when the forklift is identified (events with the event code of the event code 1) may be pulled, and whether any person is detected around the forklift (for example, within a preset distance range from a forklift as the center) is determined according to a processing element in a configured strategy; and if any person is detected, an event message is output through an event output element, and an event code of the output event message is adjusted from the event code 1 to the event code 2 (the event code 2 is used to identify that the event type is that there is a person around the forklift).

In addition, any strategy obtained by arranging according to the method shown in FIG. 1 may be verified, for example, whether the strategy includes an event input element, an event output element, and at least one processing element; whether the connection is complete, for example, whether there is an element that is not connected to any other element; whether parameters that must be filled in each element are configured, for example, whether event source information is configured for the event input element; whether an output address is configured for the event output element; and whether a filter condition is configured for the filter element. Therefore, the integrity and executability of the strategy can be verified.

In addition, test data (which may be a simulated event) may also be used to verify effect of the strategy, for example, whether the strategy can achieve an expected effect. When the strategy is verified in the foregoing manner and the verification is successfully passed, a status of the strategy may be set to verified; otherwise, the status of the strategy may be set to not verified.

For a strategy with the statues of verified, the strategy may be directly executed without re-verification. In addition, for a verified strategy, when it is determined, according to a running effect of the strategy, that parameter adjustment needs to be performed on the strategy, running effect verification may be performed on the strategy after the parameter adjustment according to a historical event message within a preset time, and when it is determined that the running effect of the strategy after the parameter adjustment meets a condition, message processing is performed according to the strategy after the parameter adjustment.

For example, for a strategy used for fishing event detection, if parameters used for fishing detection, such as a threshold value of an overlap level between a person and a fishing rod and a confidence level of the fishing rod, are not suitably set when the strategy is initially configured, there may be many false reports, in this case, parameter adjustment may be performed on the configured strategy, running effect verification is performed on the strategy after the parameter adjustment according to a historical event message within a certain time, and when it is determined that the running effect of the strategy after the parameter adjustment satisfies a condition, message processing is performed according to the strategy after the parameter adjustment.

In some embodiments, running the processing elements according to the running sequence may include: for any one of the running processing elements, when it is determined that the to-be-processed event message does not meet a condition for outputting from the processing element to a next element, stopping running the processing element, and outputting the to-be-processed event message to a specified address.

For example, in a process of running a processing element, for any processing element, when running the processing element, it may be determined whether the to-be-processed event message meets the condition to output the processing element to the next element.

For example, for the filter element, it may be determined whether a specified field in the to-be-processed event message matches a preset filter condition, and if the specified field in the to-be-processed event message matches the preset filter condition, it is determined that the to-be-processed event message does not meet the condition to output the processing element to the next element; otherwise, it is determined that the to-be-processed event message meets the condition to output the processing element to the next element.

For example, for an unfiltered element, it may be determined by default that a to-be-processed event message meets a condition to output from the processing element to a next element.

It should be noted that, in practical applications, for one processing element, there may be a plurality of next elements, that is, there are a plurality of output branches, and in this case, it is necessary to determine which element to output according to the to-be-processed event message and a preset determination logic.

Taking the shunt element as an example, the shunt element may be configured with a preset determination rule, and different next elements may be jumped to according to a determination result of running the shunt element. For example, the determination results “yes” and “no” of the shunt element may correspond to different branches, and during strategy configuration, different branches of the shunt element may be connected to different processing elements according to processing logic under different determination results of the shunt element, and further, during running of the shunt element, a corresponding next element may be determined according to whether the determination result is “yes” or “no”.

Still taking the above forklift recognition scenario as an example, the determination logic in the shunt element may be whether a size of the forklift detection block is greater than a preset size threshold, and if the size is not greater than the preset size threshold, the captured image needs to be magnified. Correspondingly, during strategy configuration, a determination result of the shunt element is yes (the size of the forklift detection block is greater than the preset size threshold), and the corresponding next element may be a human body detection element for performing human body detection according to the original captured image to determine whether there is any person around the forklift; otherwise, the corresponding next element may be an image magnifying and capturing element, so as to magnify the captured image of the forklift identification event by running the image magnifying and capturing element. When the shunt element is running, a next element may be determined according to a determination result.

For example, for any running processing element, when it is determined that the to-be-processed event message does not meet the condition to output the processing element to the next element, that is, it is determined that the to-be-processed event message needs to be intercepted, the to-be-processed event message may be rejected from being output to the next element, and the to-be-processed event message is output to the specified address.

For example, messages that need to be intercepted in a process of running any processing element may be uniformly output to a specified address, for example, the intercepted messages are output to the specified address through a bus.

For example, the to-be-processed event message output to the specified address may further carry an output reason, that is, a reason for intercepting the to-be-processed event message, so that a related person can subsequently determine, based on the output reason, a reason for intercepting the to-be-processed event message.

In some embodiments, when the running instruction for the target strategy is detected, the message processing method provided in this embodiment of the present disclosure further includes: persistently storing the output event message, or the output event message and the output reason of the event message that are output when the target strategy is running; and when a search instruction for the persistently stored event message is detected, searching, from the persistently stored event messages, for the event message that matches a search condition indicated by the search instruction and the output reason corresponding to the event message.

For example, the event message output when the target strategy is running may include an event message output when the event output element is running, and also include an event message output when the processing element is running, for example, an event message that is determined not satisfied to be output to a next element when a certain processing element is running.

For example, for an event message that is output when a processing element is running, an output reason of the event message may be output, where the output reason may include identification information of the processing element that outputs the event message and a reason for outputting the event message by the processing element, so that a related person may perform strategy execution backtracking, for example, query a strategy execution link of each event message (for example, the event message is processed by which elements) and a processing result (for example, whether the event message belongs to a message intercepted by a strategy (for example, whether the message is a false alarm or repeated alarm data)).

For example, the search condition may include, but is not limited to, a time range and/or a space range.

For example, in a process of persistently storing the event message and the output reason of the event message that are output when the target strategy is running, a storage medium may be switched based on a stored data volume.

For example, when the data volume is less than a preset data volume threshold, the output event message and the output reason of the event message may be stored in a database; and when the data volume is greater than or equal to the preset data volume threshold, a storing manner of ES (elastic search, an index-based distributed storing manner) is adopted for storing.

It should be noted that, in the embodiments of the present disclosure, the event message intercepted by the strategy may be converted to valid output after manual check, for example, output to a valid alarm message queue.

For example, the solution provided in the embodiments of the present disclosure further supports strategy effect statistics, for example, counting a total quantity of policies and a running status of each strategy (for example, running, not running, abnormal, or not verified); and counting a quantity of original event messages (that is, a quantity of originally reported event messages), a quantity of intercepted event messages (or referred to as a quantity of filtered event messages), and a quantity of strategy output event messages (that is, a quantity of event messages output by an event output element of a strategy, and may also be referred to as a quantity of valid event messages).

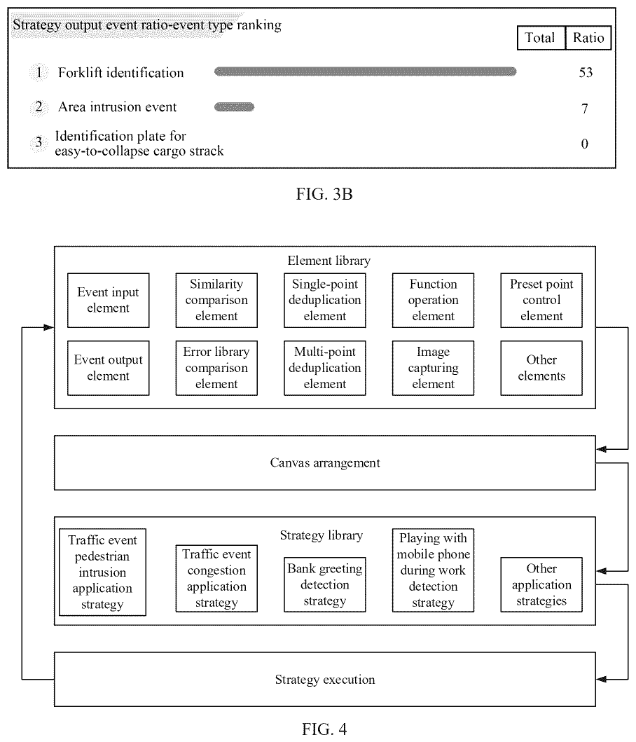

For example, a statistical result may be displayed in a form of a list according to the event type. For any type of event, display content of the event may include, but is not limited to, a quantity of original event messages, a quantity of intercepted event messages, a quantity of output event messages of a strategy, and a proportion of filtered event messages (that is, a ratio of the quantity of filtered event messages to the quantity of original event messages), and a schematic diagram is shown in FIG. 3A.

For any type of event, data trend prediction may further be performed based on statistical data, for example, times of reporting the type of event increases or decreases.

In addition, based on the statistical data, a quantity of strategy output event messages of different types of events and a ratio of strategy output event messages of different types of events (for example, a ratio of a quantity of strategy output event messages of one type of event to a sum of quantities of strategy output event messages of all types of events) can be determined, which may be displayed according to quantity sorting or proportion sorting, and a schematic diagram thereof is shown in FIG. 3B.

The method provided in the present disclosure is described above. The following describes an apparatus provided in the present disclosure.

FIG. 6 is a schematic structural diagram of a strategy arranging apparatus provided by an embodiment of the present disclosure, as shown in FIG. 6, a strategy arranging apparatus may include:
a first determining unit 610, configured to determine a target event that needs to be performed with strategy arrangement;
an arranging unit 620, configured to: adding, according to a detected element add instruction, a target element pointed by the element add instruction to a strategy visualized arranging interface, where the target element includes processing elements, and the processing elements include at least one of a function element, an algorithm element, and an execution element; where the function element is configured to perform logical operation processing on to-be-processed data, the algorithm element is configured to perform algorithm processing on the to-be-processed data by using a preset algorithm, and the execution element is configured to control a specified device to perform a corresponding action;
a second determining unit 630, configured to determine a connection relation between the processing elements according to a detected connection operation instruction for the processing elements in the strategy visualized arranging interface; and determine parameters of the processing elements according to a detected parameter editing instruction for the processing elements in the strategy visualized arranging interface; and
a generating unit 640, configured to generate and save a strategy of the target event according to the processing elements, the connection relation between the processing elements, and the parameters of the processing elements when a strategy saving instruction is detected.

In some embodiments, the target element further includes an event input element;
the first determining unit 610 is specifically configured to: when a strategy arranging instruction for the target event is detected, create the event input element for the target event, where the event input element is set with event source information, and the event source information is used to acquire an event message of the target event according to the event source information when the event input element is running; or when an event input element creation instruction is detected, create an initial event input element; determine the event input element of the target event according to a detected event identifier configuration instruction for the initial event input element;
the arranging unit 620 is further configured to: determine a connection relation between the event input element and the processing elements according to a detected connection operation instruction for the event input element.

In some embodiments, the target element may further include an event output element, and the event output element is provided with an output address for outputting data according to the output address when the event output element is running;
the arranging unit 620 is further configured to: determine a connection relation between the event output element and the processing elements according to a detected connection operation instruction for the event output element.

In some embodiments, the second determining unit 630 is specifically configured to: when an operation instruction for pasting an event message of the target event to a specified area of an event message parsing interface is detected, parse the event message of the target event, determine field information included in the event message of the target event, and display the field information; and determine the parameters of the processing elements according to the detected parameter editing instruction for a target field in the event message for the target event.

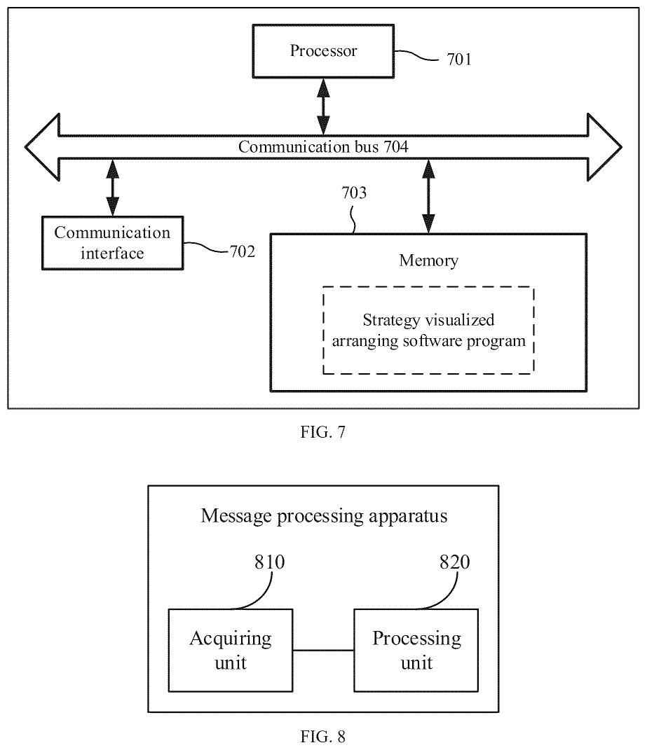

FIG. 7 is a schematic diagram of a hardware structure of a strategy arranging device according to an embodiment of the present disclosure. The strategy arranging device may include a processor 701, a communication interface 702, a memory 703, and a communication bus 704. The processor 701, the communication interface 702, and the memory 703 communicate with each other by using the communication bus 704. The memory 703 stores a strategy visualized arranging software program; and the processor 701 may perform the strategy arranging method described above by executing the strategy visualized arranging software program stored in the memory 703.

The memory 703 referred to herein may be any electronic, magnetic, optical, or other physical storage device, may contain or store information, such as executable instructions, data, and so forth. For example, the memory 703 may be a random access memory (RAM), a volatile memory, a non-volatile memory, a flash memory, a storage drive (such as a hard disk drive), a solid state drive, any type of storage disk (such as an optical disk, dvd, etc.), or a similar storage medium, or a combination thereof.

An embodiment of the present disclosure further provides a computer-readable storage medium storing a strategy visualized arranging software program, for example, the memory 703 in FIG. 7, and the software program may be executed by the processor 701 in the strategy arranging device shown in FIG. 7 to implement the strategy arranging method described above.

An embodiment of the present disclosure further provides a strategy visualized arranging software program, stored in a computer-readable storage medium, for example, the memory 703 in FIG. 7, and when a processor executes the strategy visualized arranging software program, the processor 701 is caused to perform the strategy arranging method described above.

FIG. 8 is a schematic structural diagram of a message processing apparatus provided by an embodiment of the present disclosure, and as shown in FIG. 8, the message processing apparatus may include:
an acquiring unit 810, configured to acquire a target element included in a target strategy when a running instruction for the target strategy is detected, where the target strategy is generated by arranging according to the strategy arranging method described above;
a processing unit 820, configured to determine a running sequence of the processing elements according to the connection relation between the processing elements in the target element, and run the processing elements according to the running sequence, so that the running processing elements process a to-be-processed event message by using a corresponding parameter.

In some embodiments, the target element further includes an event input element;
the processing unit 820 is further configured to: run the event input element in the target element, and acquire the to-be-processed event message according to event source information set in the event input element.

In some embodiments, the target element further includes an event output element;
the processing unit 820 is further configured to: when the event output element in the target element is running, output data according to an output address set in the event output element.

In some embodiments, the processing unit 820 is specifically configured to: for any one of the running processing elements, when it is determined that the to-be-processed event message does not meet a condition for outputting from the processing element to a next element, stop running the processing clement, and output the to-be-processed event message to a specified address.

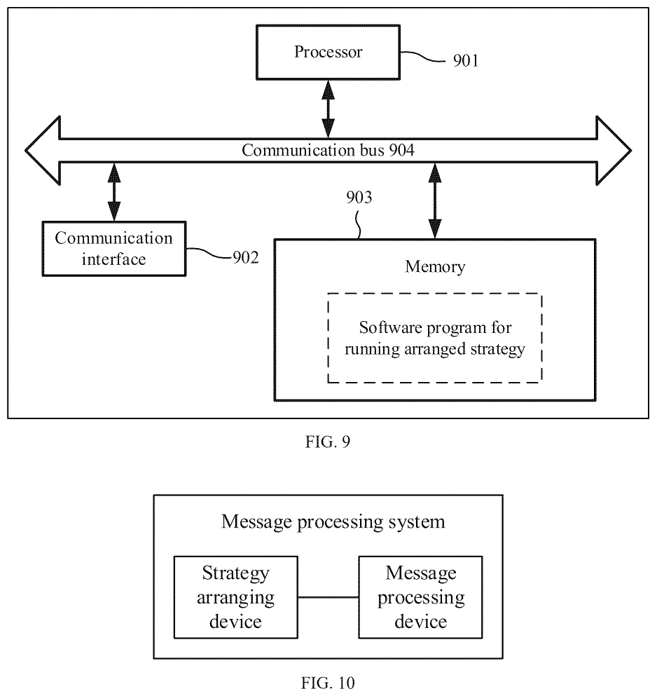

FIG. 9 is a schematic diagram of a hardware structure of a message processing device according to an embodiment of the present disclosure. The message processing device may include a processor 901, a communication interface 902, a memory 903, and a communication bus 904. The processor 901, the communication interface 902, and the memory 903 communicate with each other by using the communication bus 904. The memory 903 stores a software program for running an arranged strategy; and the processor 901 may perform the message processing method described above by executing the software program for running the arranged strategy stored in the memory 903.

The memory 903 referred to herein may be any electronic, magnetic, optical, or other physical storage device, may contain or store information, such as executable instructions, data, and so forth. For example, the memory 903 may be a random access memory (RAM), a volatile memory, a non-volatile memory, a flash memory, a storage drive (such as a hard disk drive), a solid state drive, any type of storage disk (such as an optical disk, dvd, etc.), or a similar storage medium, or a combination thereof.

An embodiment of the present disclosure further provides a computer-readable storage medium storing a software program for running an arranged strategy, for example, the memory 903 shown in FIG. 9, and the software program may be executed by the processor 901 in the electronic device shown in FIG. 9 to implement the message processing method described above.

An embodiment of the present disclosure further provides a software program for running an arranged strategy, where the software program is stored in a computer-readable storage medium, for example, the memory 903 shown in FIG. 9, and when a processor executes the software program for running the arranged strategy, the processor 901 is caused to perform the message processing method described above.

FIG. 10 is a schematic structural diagram of a message processing system provided by an embodiment of the present disclosure, as shown in FIG. 10, the message processing system may include: a strategy arranging device and a message processing device.

The strategy arranging device may perform strategy arrangement according to the strategy arranging method described in the foregoing embodiments; and the message processing device may perform message processing according to the message processing method described in the foregoing embodiment.

For example, a structure of the strategy arranging device may be shown in FIG. 7.

For example, a structure of the message processing device may be shown in FIG. 9.

It should be noted that, in this specification, relational terms such as first and second are merely used to distinguish one entity or operation from another entity or operation, and do not necessarily require or imply that there is any such actual relation or order between these entities or operations. Moreover, the terms “include”, “comprise” or any other variant thereof are intended to cover a non-exclusive inclusion, such that a process, method, article or device including a series of elements includes not only those elements, but also other elements not explicitly listed, or elements inherent to such process, method, article or device. Without more limitations, an element defined by a statement “including a” does not preclude the presence of another identical element in a process, method, article, or device that includes the element.

The above description is only preferred embodiments of the present disclosure and is not intended to limit the present disclosure, and any modifications, equivalent substitutions, improvements and the like made within the spirit and principle of the present disclosure shall fall within the protection scope of the present disclosure.

1. A strategy arranging method, comprising:
determining a target event that needs to be performed with strategy arrangement;
adding, according to a detected element add instruction, a target element pointed by the element add instruction to a strategy visualized arranging interface, wherein the target element comprises processing elements, and the processing elements comprise at least one of a function element, an algorithm element, and an execution element; wherein the function element is configured to perform logical operation processing on to-be-processed data, the algorithm element is configured to perform algorithm processing on the to-be-processed data by using a preset algorithm, and the execution element is configured to control a specified device to perform a corresponding action;
determining a connection relation between the processing elements according to a detected connection operation instruction for the processing elements in the strategy visualized arranging interface; and determining parameters of the processing elements according to a detected parameter editing instruction for the processing elements in the strategy visualized arranging interface; and
when a strategy saving instruction is detected, generating and saving a strategy of the target event according to the processing elements, the connection relation between the processing elements, and the parameters of the processing elements;
wherein the target element further comprises an event input element; and the method further comprises:
when a strategy arranging instruction for the target event is detected, creating the event input element for the target event, wherein the event input element is set with event source information, and the event source information is used to acquire an event message of the target event according to the event source information when the event input element is running;
or,
when an event input element creation instruction is detected, creating an initial event input element; determining the event input element of the target event according to a detected event identifier configuration instruction for the initial event input element;
after adding, according to the detected element add instruction, the target element pointed by the element add instruction to the strategy visualized arranging interface. the method further comprises:
determining a connection relation between the event input element and the processing elements according to a detected connection operation instruction for the event input element.

2. (canceled)

3. The method according to claim 1, wherein the target element further comprises an event output element; the event output element is provided with an output address, and the output address is used to output data according to the output address when the event output element is running;
after adding, according to the detected element add instruction, the target element pointed by the element add instruction to the strategy visualized arranging interface, the method further comprises:
determining a connection relation between the event output element and the processing elements according to a detected connection operation instruction for the event output element.

4. The method according to claim 1, wherein determining the parameters of the processing elements according to the detected parameter editing instruction for the processing elements in the strategy visualized arranging interface comprises:
when an operation instruction for pasting an event message of the target event to a specified area of an event message parsing interface is detected, parsing the event message of the target event, determining field information comprised in the event message of the target event, and displaying the field information; and
determining the parameters of the processing elements according to a detected parameter editing instruction for a target field in the event message for the target event.

5. A message processing method, comprising:
acquiring a target element comprised in a target strategy when a running instruction for the target strategy is detected, wherein the target strategy is generated by arranging according to the method according to claim 1; and
determining a running sequence of the processing elements according to the connection relation between the processing elements in the target element, and running the processing elements according to the running sequence, so that the running processing elements process a to-be-processed event message by using a corresponding parameter.

6. The method according to claim 5, wherein the target element further comprises an event input element;
before running the processing elements according to the running sequence, so that the running processing elements process the to-be-processed event message by using the corresponding parameter, the method further comprises:
running the event input element in the target element, and acquiring the to-be-processed event message according to event source information set in the event input element.

7. The method according to claim 5, wherein the target element further comprises an event output element;
after running the processing elements according to the running sequence, so that the running processing elements process the to-be-processed event message by using the corresponding parameter, the method further comprises:
when the event output element in the target element is running, outputting data according to an output address set in the event output element.

8. The method according to claim 5, wherein running the processing elements according to the running sequence, so that the running processing elements process the to-be-processed event message by using the corresponding parameter comprises:
for any one of the running processing elements, when determining that the to-be-processed event message does not meet a condition for outputting from the processing element to a next element, stopping running the processing element, and outputting the to-be-processed event message to a specified address.

9-10. (canceled)

11. A strategy arranging device, comprising a processor, a communication interface, a memory, and a communication bus, wherein the processor, the communication interface, and the memory communicate with each other by using the communication bus;
the memory is configured to store a strategy visualized arranging software program; and
the processor is configured to perform the strategy visualized arranging software program stored in the memory to implement the strategy arranging method according to claim 1.

12-13. (canceled)

14. A message processing device, comprising a processor, a communication interface, a memory, and a communication bus, wherein the processor, the communication interface, and the memory communicate with each other by using the communication bus;
the memory is configured to store a software program for running an arranged strategy; and
the processor is configured to execute the software program for running the arranged strategy stored in the memory, to implement the message processing method according to claim 5.

15. A message processing system, comprising a strategy arranging device and the message processing device according to claim 14,
wherein the strategy arranging device comprises a processor, a communication interface, a memory, and a communication bus, wherein the processor, the communication interface, and the memory communicate with each other by using the communication bus;
the memory is configured to store a strategy visualized arranging software program; and
the processor is configured to perform the strategy visualized arranging software program stored in the memory to perform operations comprising:
determining a target event that needs to be performed with strategy arrangement;
adding, according to a detected element add instruction, a target element pointed by the element add instruction to a strategy visualized arranging interface, wherein the target element comprises processing elements, and the processing elements comprise at least one of a function element, an algorithm element, and an execution element; wherein the function element is configured to perform logical operation processing on to-be-processed data, the algorithm element is configured to perform algorithm processing on the to-be-processed data by using a preset algorithm, and the execution element is configured to control a specified device to perform a corresponding action;
determining a connection relation between the processing elements according to a detected connection operation instruction for the processing elements in the strategy visualized arranging interface; and determining parameters of the processing elements according to a detected parameter editing instruction for the processing elements in the strategy visualized arranging interface; and
when a strategy saving instruction is detected, generating and saving a strategy of the target event according to the processing elements, the connection relation between the processing elements, and the parameters of the processing elements;
wherein the target element further comprises an event input element; and the operations further comprise:
when a strategy arranging instruction for the target event is detected, creating the event input element for the target event, wherein the event input element is set with event source information, and the event source information is used to acquire an event message of the target event according to the event source information when the event input element is running;
or,
when an event input element creation instruction is detected, creating an initial event input element; determining the event input element of the target event according to a detected event identifier configuration instruction for the initial event input element;
after adding, according to the detected element add instruction, the target element pointed by the element add instruction to the strategy visualized arranging interface, the operations further comprise:
determining a connection relation between the event input element and the processing elements according to a detected connection operation instruction for the event input element.
